(19) United States
(12) Patent Application Publication
(10) Pub. No.: US 2007/0035850 A1
(43) Pub. Date: Feb. 15, 2007

(54) Method and device for reducing systematic measuring errors in the examination of objects

(75) Inventors: Lambert Danner, Wetzlar (DE); Michael Heiden, Wolfersheim (DE)

Correspondence Address: FOLEY AND LARDNER LLP;SUITE 500, 3000 K STREET NW, WASHINGTON, DC, 20007, US

(73) Assignee: LEICA MICROSYSTEMS CMS GmbH

(21) Appl. No.: 11/500,502

(22) Filed: Aug. 8, 2006

(30) Foreign Application Priority Data
Aug. 9, 2005 (DE) 10 2005 037 531.6

(51) Int. Cl. G02B 21/02

(52) U.S. Cl. 359/656

(57) ABSTRACT

In the production of semiconductor or other components, the structures are normally manufactured in different planes. In the orientation of these planes relative to each other a displacement or alignment is examined, among other things, and detected as an overlay defect. To reduce a systematic measuring defect a measuring device (10) is provided for measuring the overlay defect. This device has an illuminating device (12), a lens or objective (14) for focusing radiation from the illuminating device (12) onto the object (16) and a tube lens (18) for imaging the radiation onto a sensor unit (20). A compensator (22), in which the wave fronts of the incident radiation are tilted with spectral variation such that the axial transverse chromatic aberration is compensated for, is provided in the path of rays of the measuring device (10).

### BACKGROUND

The invention relates to a measuring device for measuring overlay defects when examining an object, such as a semiconductor, and to a method for reducing systematic measuring defects when measuring overlay defects in the examination of an object.

In semiconductor production, wafers are processed sequentially during the production process in a multiplicity of process steps in which a multiplicity of identical recurring structural elements, the so-called dies, are produced on a wafer. As the density of integration increases, the requirements regarding the quality of the structures formed on the wafers become more stringent. In order to be able to examine the quality of these structures and detect possible defects, the requirements regarding the precision and reproducibility of the components and process steps handling the wafer are correspondingly stringent. This means that in the production of a wafer with the multiplicity of process steps and the multiplicity of coats of photo resin or the like, reliable detection of the quality of the preceding process steps must be determined. In the production of semiconductor components the structures are normally produced in different planes. The orientation of the structures relative to each other in these planes is very important because too great a displacement of the structures may result in an interruption in the connection of elements between these planes. Therefore the orientation, displacement and alignment of these planes relative to each other, among other things, are examined and referred to as overlay defects.

A method for measuring the overlay defect is disclosed, for example, in US 2004/0207849. Here a method is proposed for illuminating the periodic structures present in different planes with coherent light. The optical phase difference between the negative and positive scattered light radiation is determined from the positive and negative scattered light radiation, and the overlay defect can then be determined from this phase difference.

WO 03/104929 A2 also discloses a method for measuring the overlay defect, in which image or intensity information from the surface examined is analyzed in order to determine the overlay defect sought.

In these methods, microscopes having infinity plane corrected microscope lenses are normally used for examining the structures. When microscope lenses are assembled, image defects occur due to the component tolerances. These are defects which cannot be avoided no matter how much care is taken. Therefore the centring operations, for example, are only possible within certain tolerances. For example, the position of the axis of a lens relative to the whole system can be tilted or displaced. The resultant image defects (coma, astigmatism and axial transverse chromatic aberration, the latter occurring in the center of the image) limit the accuracy of the examination and are commonly known. Normally an attempt is made to minimize coma and astigmatism by so-called setting. For astigmatism correction individual lens groups are rotated relative to each other for this purpose and the optical axis is thus balanced. A coma can be counteracted by the lateral displacement of a lens group. Although both defects cannot be completely eliminated, it is generally possible to make a correction that is so good that the measurement can be carried out uninfluenced within the desired degree of accuracy. Although axial transverse chromatic aberrations can, in principle, also be influenced by setting, the same degrees of freedom which also influence astigmatism and coma must be used for this purpose. Therefore any such correction of the axial transverse chromatic aberration also necessarily results in a variation in the correction of astigmatism and coma. The entire process must therefore be designed iteratively to prevent any of the corrections resulting in values which lie outside the acceptable tolerance. Since this process is very time consuming, and since it is also an open question, from the beginning, whether the iterative process converges, i.e. results in minimal defects, a correction of the axial transverse chromatic aberration on the axis is normally dispensed with and the resultant disadvantages are considered systematic defects.

### SUMMARY

An object of this invention is therefore to reduce the systematic measuring defects when examining objects, such as semiconductor or other structures.

A measuring device according to the invention, which can be used in particular when examining overlay defects on produced semiconductor wafers, has an illuminating device and an infinity plane corrected lens for focusing a radiation from the illuminating device onto the object, the semiconductor wafer for instance. A tube lens is provided for representing the intermediate image set to infinity onto a sensor unit, such as a CCD sensor. A compensator is provided in the path of rays of the measuring device. Here the wave fronts of the incident radiation are tilted in the compensator with spectral variation so that the axial transverse chromatic aberration is compensated for. Because of the structure of the compensator and the lens correction selected, spherical aberration, astigmatism and coma remain unaffected by the setting of the axial transverse chromatic aberration.

The compensator is preferably arranged in the pupil of the lens because the diameters used are the smallest in this position. This favors the highly accurate production of the compensator. Alternatively the compensator may also be arranged in the path of rays between the lens and the tube lens. A remagnification unit may be provided between the tube lens and the sensor unit.

The compensator may have a prism, a double prism or preferably a variable prism. The variable prism has a plano-concave and a plano-convex lens of the same material, whose spherical radii are equal and are in contact with each other. The prism is set by sliding on the interface so that the two flat surfaces form an angle with each other. This setting can be fixed with a cement between the two elements. It is particularly advantageous if the refractive index and the dispersion of the cement coincide, if possible, with the values of the glass elements. The size and direction of the compensation required is determined for setting the compensator and is set by means of the variable prism and, if necessary, fixed by means of the adhesive. To determine the required values a model object, in particular a test wafer, is used, the structures of which object, present on the test wafer, are known.

When a compensator is used in the path of rays of the measuring device, an axial transverse chromatic aberration can be compensated for without having to alter again the settings made for the astigmatism or coma correction. This is because tilting the wave fronts in the pupil of the measuring device only causes a wavelength-dependent image displacement without additional aberration variations in the case of infinity plane corrected lenses.

Further advantages and advantageous embodiments of the invention constitute the subject matter of the following figures and their descriptions, in whose representation a true to scale reproduction was dispensed with for the sake of clarity.

### BRIEF DESCRIPTION OF THE DRAWINGS

The figures show the following in particular:

FIG. 1 shows diagrammatically the occurrence of an axial transverse chromatic aberration

FIGS. 2a-2d show diagrammatically the effects of the axial transverse chromatic aberration

FIG. 3 shows diagrammatically the arrangement of a compensator in the pupil of the lens

FIG. 4 shows diagrammatically a measuring device according to the invention

FIG. 5 shows diagrammatically a further measuring device according to the invention

FIGS. 6a-6c show a diagrammatic representation of possible compensators

FIG. 7 shows diagrammatically the process of adjustment according to the invention of the compensator.

### DESCRIPTION OF PREFERRED EMBODIMENTS

In the overlay measurement for determining the overlay defect, the position of the center of two boxes is determined. As disclosed in US 2004/0207849, for example, these boxes lie in different planes of the wafer. The boxes generally differ in color because different materials are used in the layers. If the layers are positioned accurately relative to each other, the centers of the boxes lie exactly one above the other so that it can be determined with this measurement whether the structures are positioned sufficiently accurately relative to each other in the layers. This is extremely important because even minor deviations can result in a malfunction of the chip.

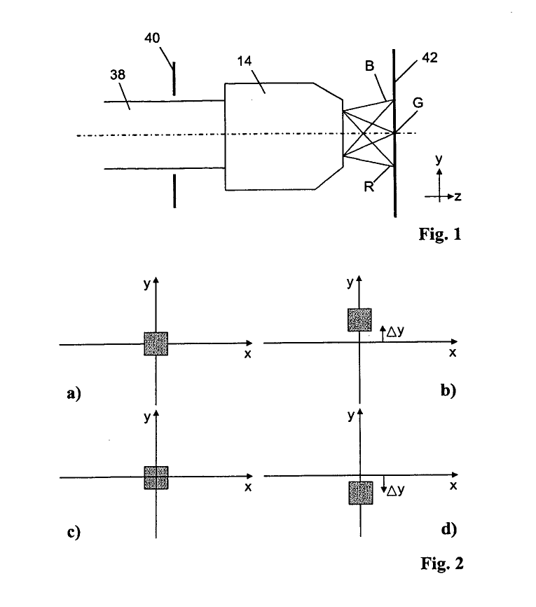

If, however, the imaging system, consisting of a lens, a tube lens and an optional remagnification, has an axial transverse chromatic aberration, a superposition defect is detected which results in misinterpretation of the measured result. FIG. 1 shows a lens 14 into which white light 38 impinges. A wavelength-dependent displacement of the point of contact of the radiation on the y-plane must be established as the typical axial transverse chromatic aberration on the output side of lens 14, i.e. opposite pupil 40. It is shown diagrammatically that the radiation with red wavelength R, the radiation with green wavelength G and the radiation with blue wavelength B arrive in different positions of the y-direction of image plane 42. Unlike many other image defects, the axial transverse chromatic aberration may already be observed in the center of the image.

FIG. 2a shows the actual position of a green object. Here a sensor unit, for example a CCD camera, can be adjusted so that the image of the object comes to lie in the center of the image, as shown in FIG. 2c. Now if an axial transverse chromatic aberration exists, a displacement in the positive y-direction may be observed for a blue object, as shown in FIG. 2b. Correspondingly a red object is displaced in the negative y-direction, as shown in FIG. 2d. The effect of the axial transverse chromatic aberration therefore is that an image displacement of Δy is produced, depending on the color of the object. This displacement influences the measurement considerably whenever a plurality of colors are to be represented simultaneously, because in this case compensation by recentring the CCD camera is not possible.

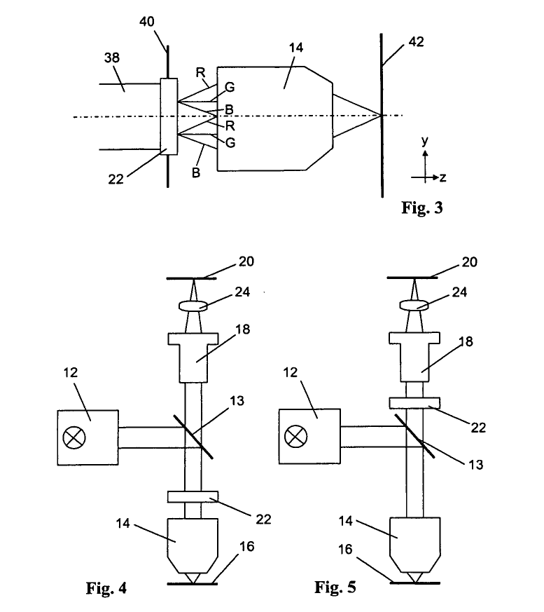

According to the invention it has been shown that the tilting of the wave front in the pupil of the optical system, in the case of an infinity plane corrected lens, merely results in an image displacement without an additional aberration being introduced. The axial transverse chromatic aberration may therefore be compensated for by inserting a compensator 22 which causes wavelength-dependent tilting of the wave front. As shown in FIG. 3, this compensator 22 is preferably provided in pupil 40 of lens 14. This is because the axial transverse chromatic aberration of lens 14 can thus be compensated for. With compensator 22 there is already wavelength-dependent tilting of the wave fronts of the white input radiation 38, but this corresponds exactly to an image displacement which is then wavelength-dependent. Compensator 22 is specifically designed so that the tilting of the wave fronts is equal and opposite to the image displacement caused in lens 14 by the axial transverse chromatic aberration. The axial transverse chromatic aberration in lens 14 is therefore corrected again. As shown in FIG. 3, the compensator is preferably arranged in pupil 40. Compensator 22 may also be provided at another point in the path of rays of measuring device 10, particularly if it is not accessible.

FIG. 4 shows a measuring device 10 (such as for example a microscope, a macroscope, a confocal microscope, multiple optical devices to compare or superimpose images, a forensic macroscope, a forensic microscope) for this purpose. This arrangement has an illuminating device 12 from which light is transmitted to an incident light splitter 13. The illuminating light for object 16, i.e. the wafer, passes through compensator 22 and is transmitted via lens or objective 14 to object 16. Here compensator 22 is designed so that it compensates for the axial transverse chromatic aberration of objective 14, and is positioned between tube lens 18 (which may contain one or more individual lens elements) and lens 14 on the lens side of incident light splitter 13. A remagnification device 24 can optionally be provided between tube lens 18 and sensor device 20 at an image plane, at which a CCD sensor, CCD camera, scanner, a pinhole or image sensor, scanning line camera, position sensitive detector, intensity ratio sensor, etc. may be provided.

An alternative arrangement is shown in FIG. 5. This arrangement again has an illuminating device 12 from which light is transmitted to an incident light splitter 13. The illuminating light for object 16, i.e. the wafer, is transmitted via lens 14 to object 16. A compensator 22 is positioned between tube lens 18 and lens 14 on the tube lens side of incident light splitter 13, and is designed here so that it compensates for the axial transverse chromatic aberration of lens 14. A remagnification device 24 can again be optionally provided between tube lens 18 and sensor device 20, which is typically designed as a CCD sensor or CCD camera.

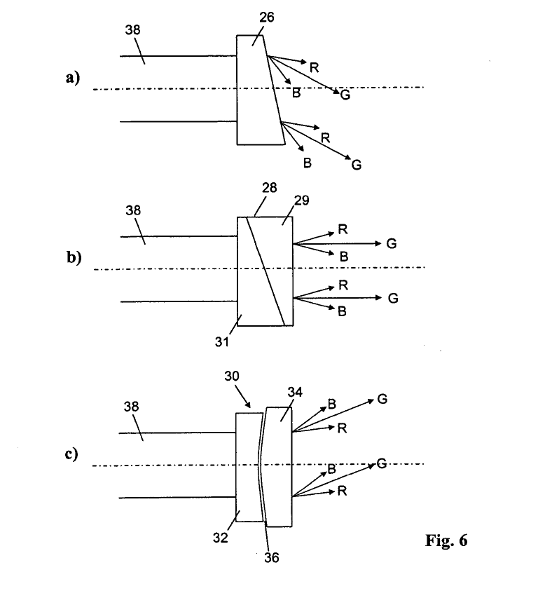

FIG. 6 shows different embodiments of compensator 22. Thus compensator 22, as shown in FIG. 6a, may have a prism 26 or wedge plate which is preferably positioned in the system pupil. The prism breaks down incident white light 38 into its spectral constituents which, by way of example, are again represented as R, G and B. In such a prism, however, the main wavelength is also tilted, which can of course again be easily compensated for by suitable positioning of the CCD camera.

As shown in FIG. 6b, a double prism 28 may also be used. This has two prisms 29, 31 which are preferably manufactured from glass and which differ only in their dispersion. The two glasses are glued to each other. The refractive index of such glasses is the same for green, so that here there is no tilting of the main color and the CCD camera need not therefore be repositioned. The camera need not therefore be tracked during the adjustment.

FIG. 6c shows a variable prism which can also be used for correcting the axial transverse chromatic aberration. This is advantageous whenever different lenses 14 are to be used, because the axial transverse chromatic aberration varies from one lens to another. Using a variable prism 30 this situation can be reacted to and the spectrally variable tilting of the wave fronts can be set according to the characteristics of the system used in each case by selecting different lip angles of the outer faces of elements 32 and 34 relative to each other. Elements 32 and 34 can be fixed in their relative positions after the desired effect is obtained, i.e. after the best lip angle has been found. For this purpose the elements can be permanently joined together with an adhesive 36, preferably an UV activatable adhesive. The adjustment is therefore carried out first with adhesive 36, not yet set, and the desired position sought. Once this position has been found, adhesive 36 can be activated, e.g. by means of a UV flash.

When constructing measuring device 10 (FIG. 4), compensator 22 is also positioned at a suitable time. Ideally compensator 22 is positioned in lens pupil 40. Here, however, the problem often arises that the lens as a sealed component is not accessible. Compensator 22 can therefore also be positioned between lens 14 and tube lens 18, as shown in FIGS. 4 and 5. After positioning, the axial chromatic aberration of the entire measuring device 10 is compensated for by means of compensator 22 by adjusting compensator 22. The adjustment is in this case made by means of a test wafer, which has a known structure.

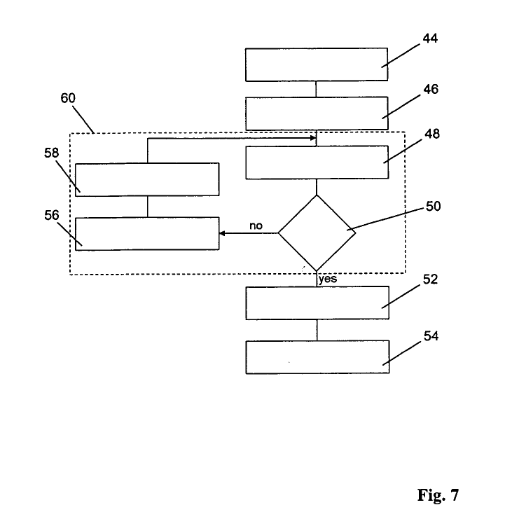

FIG. 7 shows diagrammatically the process for adjusting compensator 22. A new compensator 22, with a variable prism 30 and an adhesive 36 in step 44, is first assembled in step 44 in measuring device 10. In step 46 a test wafer is loaded, i.e. is positioned in the measuring device so that it can be examined. Values from which the direction and amount of the transverse chromatic aberration can be determined in the axial direction are then recorded with measuring device 10 in step 48. In step 50 it is now determined whether these values lie within a predetermined range of values acceptable for measuring device 10. If this is the case the current position of spherical elements 32, 34 are fixed in step 52, in which step adhesive 36, in particular, is set by means of UV radiation for example. According to the adhesive system, radiation with UV light must continue until the adhesive has set or until setting is merely initiated with a UV flash. Moreover, other adhesives can also be used, but preferably those which set quickly after initiation. Finally the test wafer is unloaded again in step 54.

If it appears in step 50 that the values of the axial transverse chromatic aberration determined in step 48 are outside the predetermined range of values acceptable for measuring device 10, it is necessary to adjust compensator 22. For this purpose the direction and amount of the variation of compensator 22 is calculated in step 56. In the subsequent step 58 compensator 22 is reset. For this purpose the lip angle of both elements 32, 34 may be varied so that the defect is compensated for. The direction and amount of the axial transverse chromatic aberration are then measured again in step 48. Since the adjustment process does not run linearly, it is necessary to run correction loop 60 iteratively to achieve the optimum result. Loop 60 is then abandoned as soon as it is established in step 50 that the values lie within a predetermined range of values acceptable for measuring device 10.

If the compensator is equipped with actuators (e.g. piezos), the adjustment process can be controlled automatically by a computer.

In principle it is also possible, particularly for measuring devices 10 for which there are less stringent requirements, for the correction not to be made iteratively in loop 60 but to make use of a compensator 22 which is taken from a kit of prefabricated, possible compensators. In this case the establishment of the amount and direction of the axial transverse chromatic aberration in step 48 serves to determine the compensator to be used from the set of prefabricated compensators and its installation orientation. The number and grading of the compensators within a kit are in this case determined from the tolerance considerations of the optics to be applied in each case.

With the proposed measuring device and proposed method it is possible to improve substantially the quality of a measuring device for measuring overlay defects in examining an object. For a lens, and moreover for the entire system, the axial transverse chromatic aberration can be compensated for. Unlike known setting in the lens, the proposed method does not disturb the corrections of astigmatism and coma already made. In principle this method also guarantees convergence so that defects which also arise in optical components other than the lens may also be taken into consideration.

The invention may be applied in a wide variety of applications other than semiconductor applications. The invention may be applied where axial transverse chromatic aberration might cause mistakes in an image or in measurement made on the basis of such an image. For example, the invention may be used with multiband fluorescent excitation (such as described in U.S. Pat. Nos. 6,747,280 and 7,079,316, whose entire contents are incorporated herein by reference regarding such techniques) such as FISH (Fluorescence-In-Situ Hybridization), forensic applications (such as described in U.S. Patent Application Publication No. 2004/0090671, whose entire contents are incorporated herein by reference regarding such techniques), and confocal microscopy.

Although the present invention has been described with reference to specific embodiments, also shown in the appended drawings, it will be apparent for those skilled in the art that many variations and modifications can be done within the scope of the invention as described in the specification and defined with reference to the claims below. The entire contents of German application DE 10 2005 037 531.6 filed Aug. 9, 2005 and on which this U.S. application is based, are incorporated herein by reference.

List of Reference Numbers

10 Measuring device
12 Illuminating device
13 Incident light splitter
14 Lens
16 Object
18 Tube lens
20 Sensor unit
22 Compensator
24 Remagnification unit
26 Prism
28 Double prism
30 Variable prism
32 Plano-concave element
34 Plano-convex element
36 Adhesive
38 White light
40 Pupil
42 Image plane
44 Assembly of new compensator
46 Assembly of test structure
48 Determination of the values of the axial transverse chromatic aberration
50 Values within permissible value range?
52 Setting adhesive
54 Unloading test structure
56 Calculate variation
58 Reset compensator
60 Correction loop
R Red light (general, wavelength 1)
G Green light (general, wavelength 2)
B Blue light (general, wavelength 3)

What is claimed is:

1. An optical device for imaging an object, comprising:
an illuminating device;
an objective for directing radiation from the illuminating device onto the object;
a lens for imaging radiation from the object onto an image plane; and
a compensator provided in the path of rays of the optical device, wherein the compensator tilts wave fronts of incident radiation with spectral variation such that axial transverse chromatic aberration is compensated for.

2. An optical device according to claim 1, wherein a sensor unit is arranged in the image plane.

3. An optical device according to claim 2, wherein said sensor unit is a CCD camera or a scanning line camera.

4. An optical device according to claim 2, wherein said sensor unit is a position sensitive detector.

5. An optical device according to claim 1, further comprising a scanner unit arranged in the image plane.

6. An optical device according to claim 1, wherein the optical device is a microscope.

7. An optical device according to claim 1, wherein the optical device is a microscope that is capable of fluorescent illumination.

8. An optical device according to claim 1, wherein the optical device is a microscope that is capable of multiband wavelength fluorescent illumination.

9. An optical device according to claim 1, wherein the optical device is a comparison optical device comprising two integrated macroscopes.

10. An optical device according to claim 1, wherein the optical device is a comparison optical device comprising two integrated microscopes.

11. An optical device according to claim 1, wherein the optical device is a confocal microscope and a detection pinhole is arranged in the image plane.

12. An optical device according to claim 1, wherein the compensator is arranged in the path of rays between the objective and the lens.

13. An optical device according to claim 1, wherein the compensator is arranged in a pupil of the objective.

14. An optical device according to claim 1, further comprising a remagnification unit provided between the lens and the image plane.

15. An optical device according to claim 1, wherein the compensator comprises a prism.

16. An optical device according to claim 1, wherein the compensator comprises a double prism.

17. An optical device according to claim 1, wherein the compensator comprises a variable prism, wherein the variable prism comprises a plano-convex and a plano-concave lens.

18. An optical device according to claim 17, wherein the plano-convex and plano-concave lenses are of the same material.

19. An optical device according to claim 17, wherein the piano-convex and plano-concave lenses have formed spherical surfaces, wherein the lenses lie one on top of the other, and the prism is set by sliding on the spherical surfaces such that two flat surfaces of the piano-convex and plano-concave lenses form an angle with each other.

20. An optical device according to claim 19, wherein setting of the variable prism is fixed with an adhesive.

21. A measuring device for measuring overlay defects when examining an object, comprising:
an illuminating device;
an objective for directing radiation from the illuminating device onto the object;
a lens for imaging radiation from the object onto a sensor unit; and
a compensator provided in a path of rays of the measuring device, wherein the compensator tilts wave fronts of incident radiation with spectral variation such that axial transverse chromatic aberration is compensated for.

22. A measuring device for measuring overlay defects according to claim 1, wherein the compensator is arranged in a path of rays between the objective and the lens.

23. A measuring device for measuring overlay defects according to claim 21, wherein the compensator is arranged in a pupil of the objective.

24. A measuring device for measuring overlay defects according to claim 21, wherein a remagnification unit is provided between the lens and the sensor unit.

25. A measuring device for measuring overlay defects according to claim 21, wherein the compensator comprises a prism.

26. A measuring device for measuring overlay defects according to claim 21, wherein the compensator comprises a double prism.

27. A measuring device for measuring overlay defects according to claim 21, wherein the compensator comprises a variable prism, wherein the variable prism comprises a plano-convex and a plano-concave lens.

28. A measuring device for measuring overlay defects according to claim 27, wherein the plano-convex and plano-concave lenses are of the same material.

29. A measuring device for measuring overlay defects according to claim 27, wherein the plano-convex and piano-concave lenses have formed spherical surfaces, wherein the lenses lie one on top of the other, and the prism is set by sliding on the spherical surfaces such that two flat surfaces of the plano-convex and plano-concave lenses form an angle with each other.

30. A measuring device for measuring overlay defects according to claim 29, wherein setting of the variable prism is fixed with an adhesive.

31. A method for reducing systematic measuring errors when measuring overlay defects when examining an object, with a measuring device, wherein a compensator is provided in the measuring device, which compensator is set and/or selected such that wave fronts impinging into the compensator are tilted according to their wavelength such that an axial transverse chromatic aberration is compensated for.

32. A method for reducing systematic measuring errors when measuring overlay defects when examining a semiconductor wafer, with a measuring device, wherein a compensator is provided in the measuring device, which compensator is set and/or selected such that wave fronts impinging into the compensator are tilted according to their wavelength such that an axial transverse chromatic aberration is compensated for.

33. A method for reducing systematic measuring errors according to claim 31, wherein the compensator has an adjustable prism and the size and direction of compensation are set.

34. A method for reducing systematic measuring errors according to claim 33, wherein the adjustable prism has elements which are suspended in a rotary device.

35. A method for reducing systematic measuring errors according to claim 32, wherein the compensator is adjusted using a test wafer.

36. A method for reducing systematic measuring errors according to claim 35, wherein a test wafer is loaded for adjusting the compensator and it is determined, by the test wafer, whether an amount and/or direction of the axial transverse chromatic aberration lie within a predetermined specification range.

37. A method for reducing systematic measuring errors according to claim 36, wherein the compensator is reset when the amount or direction of the axial transverse chromatic aberration lies outside the predetermined specification range.

38. A method for reducing systematic measuring errors according to claim 33, wherein the adjustable prism present in the compensator is fixed by a layer of adhesive between elements being set by UV radiation.

39. A method for reducing systematic measuring errors according to claim 33, wherein adjustment is carried out automatically by a manipulator which is controlled by a computer unit.

40. A method for reducing systematic measuring errors according to claim 33, wherein adjustment is carried out by a fine tuner which receives information from a computer unit on orientation and size of the axial transverse chromatic aberration.

41. A method for reducing systematic measuring errors according to claim 31, wherein a suitable compensator is selected from a kit of prefabricated compensators according to a measured amount of axial transverse chromatic aberration, and is installed orientated according to a direction of the axial transverse chromatic aberration.

42. A method for reducing systematic measuring errors according to claim 41, wherein the kit comprises wedge plates.

43. A method for reducing systematic measuring errors according to claim 41, wherein the kit comprises a double prism.

44. A method for reducing systematic measuring errors according to claim 41, wherein the kit comprises variable prisms.
